(19) United States
(12) Patent Application Publication
(10) Pub. No.: US 2022/0375442 A1
(43) Pub. Date: Nov. 24, 2022

(54) CALCULATION FORMULA OF PYTHAGOREAN TUNING

(71) Applicant: Genfang CHEN, Zhejiang (CN)

(72) Inventor: Genfang CHEN, Zhejiang (CN)

(21) Appl. No.: 17/622,869

(22) PCT Filed: Dec. 9, 2020
(86) PCT No.: PCT/CN2020/134784

§ 371 Date: Dec. 27, 2021

(30) Foreign Application Priority Data
Nov. 18, 2020 (CN) 202011296127.4

(51) Int. Cl. G10H 1/02; G06F 17/11

(52) U.S. Cl. CPC G10H 1/02; G06F 17/11; G10H 2250/131

(57) ABSTRACT

The present invention relates to a calculation formula of Pythagorean tuning. It specifically comprises: inputting the initial frequency of the musical tuning, the number of downward tone and the number of upward tone through an input module, then calculating a corresponding frequency value by utilizing a calculation module, and outputting the corresponding frequency value through an output module. Compared with the traditional calculation method, the present invention has the advantages that: the present invention inputs the initial frequency of the musical tuning, the number of downward tone and the number of upward tone utilizing an input module, and calculates the corresponding frequency value by utilizing a calculation module, and outputs the corresponding frequency value through an output module, especially the obtained tone sequence can be played by various musical instruments through the sound output unit in the output module, which is convenient for music practitioners to use.

### FIELD OF TECHNOLOGY

The present invention belongs to the field of modern music industry, and in particular relates to a calculation formula of Pythagorean tuning.

### BACKGROUND

In the field of art of music, tone is one of the main contents of music practice and music research. The circle-of-fifths is a kind of tuning system of a tone, which is often called Pythagorean tuning in western countries. It was independently put forward by Pythagorean School in ancient Greece. It has a history of more than 2,000 years and is widely used all over the world. Most existing musical instruments adopt the method of Pythagorean tuning as the method, which has made great contributions to the inheritance and development of music cause of all mankind.

However, the modern world has entered the era of digital music, and the internationally popular Pythagorean tuning still adopts the method of generating tone proposed by

Pythagorean School, which is no longer suitable for the rapid development of digital music. FIG. 1 shows the sequence diagram of the commonly used method of generating tone by Pythagorean School, and its basic rule is as follows: the initial frequency of the musical tuning is artificially given, for example, the frequency of the central C of the musical tones system in western music is usually 261.63 Hz as the initial frequency, and the tone is generated in chain in two directions, namely, the pure fifths upward and the pure fifths downward. The pure fifths upward means that the frequency of the current tone is multiplied by the multiplication factor 3/2 or 3/4, and if the frequency of the current tone is multiplied by 3/2 does not exceed twice the initial frequency of the musical tuning, then the frequency of the next tone is the frequency of the current tone multiplied by 3/2; otherwise, it is multiplied by 3/4. The previous line (1) in FIG. 1 indicates that starting from the center C of the tones system in western music, generates tuning according to the pure fifths upward, the next tone can be obtained by multiplying by 3/2 or 3/4. The pure fifths downward means that the frequency of the current tone is multiplied by the multiplication factor 2/3 or 4/3, and if the frequency of the current tone is multiplied by 4/3 does not exceed twice the initial frequency of the starting tone of the tuning, then the frequency of the next tone is the frequency of the current tone multiplied by 4/3; otherwise, it is multiplied by 2/3. The next line (1) in FIG. 2 indicates that starting from the center C of the tones system in western music, generates tone according to the pure fifths downward, the next tone can be obtained by multiplying by 2/3 or 4/3. Although this method restricts the generated tone to less than 2 times of the initial frequency of the musical tuning, the multiplication factor should be selected for every calculation. At the same time, in order to calculate the frequency of a certain tone, each tone in front of it must be calculated first. If the frequency of the step b in a certain diatonic scale of the tones system is to be calculated, the frequencies of four steps such as g, d, a, and e must be calculated first respectively in the scale.

Therefore, there is an urgent need for a tone generation method that can be easily calculated, so as to solve the problem of the wide application of Pythagorean tuning in the digital music era.

### SUMMARY

In order to make up for the deficiency of the traditional calculation method, the present invention provides a technical solution for calculation formula of Pythagorean tuning.

The calculation formula of Pythagorean tuning, characterized by comprising a generation system, wherein the generation system comprises an input module, a processing and calculation module and an output module, and the processing and calculation module comprises an exponent calculation unit during upward process, a exponent calculation unit during downward process and a frequency value calculation unit, its specific steps are as follows:

step 1: inputting, by the input module, a frequency fₒ and the number N of downward tones and the number M of upward tones to be calculated, wherein the frequency f₀ is used as the frequency of the starting tone of the tuning;

step 2: obtaining a sequence G by the exponent calculation unit during upward process: calculating M values according to the formula gᵢ=└i×log₂3┘,1≤i≤m to obtain an exponent sequence G;

step 3: obtaining a sequence G′ by the exponent calculation unit during downward process: calculating N values according to the formula gⱼ^{′}=└j×log₂3┘+1,1≤j≤N to obtain an exponent sequence G′;

step 4: obtaining, by the frequency value calculation unit, frequency values of the tones needed to be calculated: calculating frequency values of the upward M tones according to a calculation formula

$${f}_{i} = {f}_{0} ⨯ \frac{{3}^{i}}{{2}^{{g}_{i}}} , 1 \leq i \leq M$$

to obtain a sequence F of the upward M frequency values; and calculating frequency values of the downward N tones according to a calculation formula

$${f}_{j}^{′} = {f}_{0} ⨯ \frac{{2}^{{g}_{j}^{′}}}{{3}^{j}} , 1 \leq j \leq N$$

to obtain a sequence F′ of the upward N frequency values;

step 5: outputting the tone sequences F and F′ by the output module.

The calculation formula of Pythagorean tuning, wherein in the step 2, the exponent calculation formula of the exponent calculation unit during upward process is as follows: gᵢ=└i×log₂3┘, 1≤i≤M, where └i×log₂3┘ represents an integer part value taken from the numerical value i×log₂3 , and i represents an integer value from 1 to M and M exponent values are calculated by the formula, and the calculated values are arranged from smallest to largest according to the size of subscript i, so as to obtain a sequence G, wherein G= [symbol] g₁, . . . , gᵢ₋₁, gᵢ, . . . , g_{M} [symbol] .

The calculation formula of Pythagorean tuning, wherein in the step 3, the exponent calculation formula of the calculation unit is as follows: gⱼ^{′}=└j×log₂3┘+1,1≤j≤N, where └j×log₂3┘ represents an integer part value taken from the numerical value j×log₂3, and j represents an integer value from 1 to N, and N exponent values are calculated by the formula, and the calculated values are arranged from smallest to largest according to the size of subscript j, so as to obtain a sequence G′, wherein G′= [symbol] gᵢ^{′}, gⱼ, gⱼ₊₁^{′}, . . . , g_{N}^{′} [symbol] .

The calculation formula of Pythagorean tuning, wherein in the step 4, the calculation formulas of the tone sequence F and the tone sequence F′ are respectively

$${f}_{i} = {f}_{0} ⨯ \frac{{3}^{i}}{{2}^{{g}_{i}}} , 1 \leq i \leq M and {f}_{j}^{′} = {f}_{0} ⨯ \frac{{2}^{{g}_{j}^{′}}}{{3}^{j}} , 1 \leq j \leq N ,$$

which are products of a fractional ratio and the starting tone of the tuning, and the numerator and the denominator of the fractional ratio are exponential values with integers 2 and 3 as the base.

Compared to the traditional calculation method, the present invention have the following advantages:

1) the present invention inputs the initial frequency of the musical tuning, the number of downward tone and the number of upward tone by utilizing an input module, and calculates the corresponding tone sequence by using the calculation module, and then outputs it through the output module, which has high calculation efficiency and is convenient for music practitioners to use;

2) the present invention provides a method for constructing the tone sequence of Pythagorean tuning and a formula for calculating the tones of Pythagorean tuning, thus realizing a formula for calculating the frequency of the tone of any given number of tones, and further realizing the purpose of applying polyphonic tone tuning system to music software;

3) the present invention provides a method for constructing the tone sequence of Pythagorean tuning, and gives the fractional ratio between the frequency value of Pythagorean tuning and the frequency of the starting tone of the tuning, and the obtained fractional ratio can be used to calculate the required decimal precision according to actual needs, so as to meet different occasions of using the tone.

### BRIEF DESCRIPTION OF THE DRAWINGS

FIG. 1 is a method of generating tone of Pythagorean tuning in the traditional calculation method;

FIG. 2 is a flow chart of the tone generating method of the present invention;

FIG. 3 is a schematic views of the circuit relation of the generating system of the present invention.

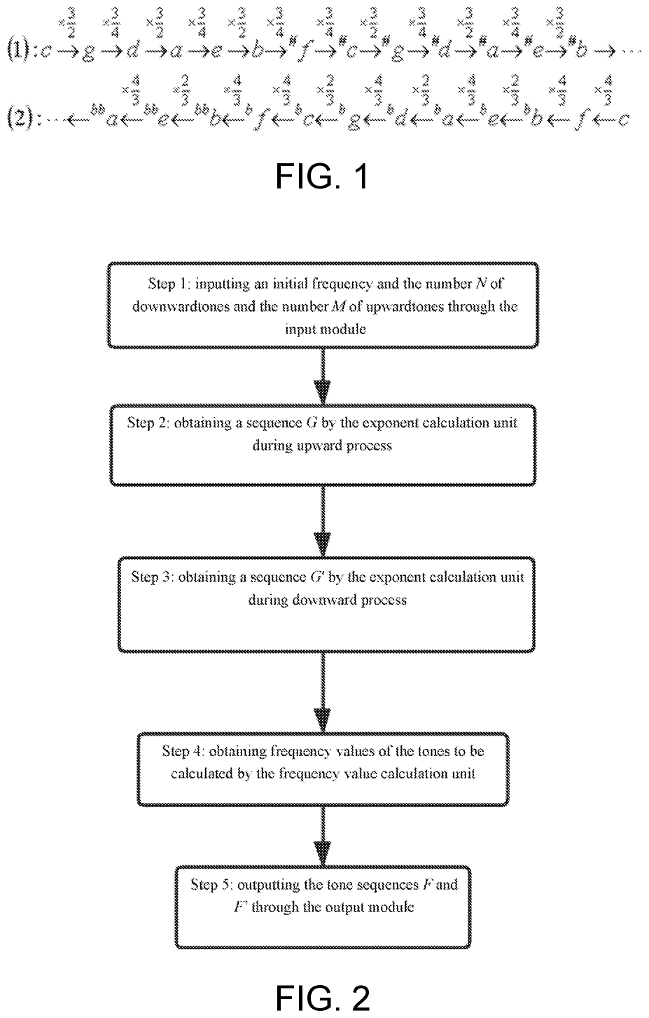

### DESCRIPTION OF THE EMBODIMENTS

The present invention will be described below with reference to drawings.

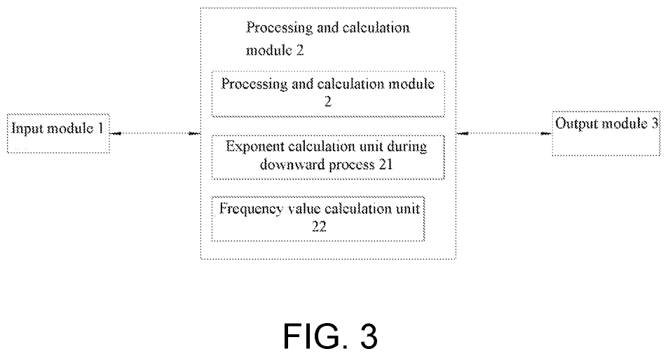

As shown in FIGS. 2 and 3, the calculation formula of Pythagorean tuning comprises a generation system, wherein the generation system comprises an input module 1, a processing and calculation module 2 and an output module 3, and the processing and calculation module 2 comprises an exponent calculation unit during upward process 20, a exponent calculation unit during downward process 21 and a frequency value calculation unit 22, its specific steps are as follows:

step 1: inputting, by the input module 1, a frequency f₀ and the number N of downward tones and the number M of upward tones to be calculated, wherein the frequency f₀ is used as the frequency of the starting tone of the tuning;

step 2: obtaining a sequence G by the exponent calculation unit during upward process 20: calculating M values according to the formula gᵢ=└i×log₂3┘, 1≤i≤M to obtain an exponent sequence G;

step 3: obtaining a sequence G′ by the exponent calculation unit during downward process 21: calculating N values according to the formula gⱼ^{′}=└j×log₂3┘+1,1≤j≤N to obtain an exponent sequence G′ ;

step 4: obtaining, by the frequency value calculation unit 22, frequency values of the tones needed to be calculated: calculating the frequency values of the upward M tones according to a calculation formula

$${f}_{i} = {f}_{0} ⨯ \frac{{3}^{i}}{{2}^{{g}_{i}}} , 1 \leq i \leq M$$

to obtain a sequence F of the upward M frequency values; and calculating frequency values of the downward N tones according to a calculation formula

$${f}_{j}^{′} = {f}_{0} ⨯ \frac{{2}^{{g}_{j}^{′}}}{{3}^{j}} , 1 \leq j \leq N$$

to obtain a sequence F′ of the upward N frequency values;

step 5: outputting the tone sequences F and F′ by the output module 3.

Further explanation of Step 2: in the step 2, the exponent calculation formula of the exponent calculation unit during upward process 20 is as follows: gᵢ=└i×log₂3┘,1≤i≤M, where └i×log₂3┘ represents an integer part value taken from the numerical value i×log₂3, and i represents an integer value from 1 to M, and Mexponent values are calculated by the formula, and the calculated values are arranged from smallest to largest according to the size of subscript i, so as to obtain a sequence G, wherein G= [symbol] g₁, . . . , gᵢ₋₁, gᵢ, . . . , g_{M} [symbol] .

Further explanation of Step 3: in the step 3, the exponent calculation formula of the calculation unit 21 is as follows: gⱼ^{′}=└j×log₂3┘+1,1≤j≤N, where └j×log₂3┘ represents an integer part value taken from the numerical value j×log₂ 3 , and j represents an integer value from 1 to N, and N exponent values are calculated by the formula, and the calculated values are arranged from smallest to largest according to the size of subscript j, so as to obtain a sequence G′, wherein G′= [symbol] g₁^{′}, . . . , gⱼ, gⱼ₊₁^{′}, . . . , g_{N}^{′} [symbol] .

Further explanation of Step 4: in the step 4, the calculation formulas of the tone sequence F and the tone sequence F′ are respectively

$${f}_{i} = {f}_{0} ⨯ \frac{{3}^{i}}{{2}^{{g}_{i}}} , 1 \leq i \leq M and {f}_{j}^{′} = {f}_{0} ⨯ \frac{{2}^{{g}_{j}^{′}}}{{3}^{j}} , 1 \leq j \leq N ,$$

which are products of a fractional ratio and the starting tone of the tuning, and the numerator and the denominator of the fractional ratio are exponential values with integers 2 and 3 as the base.

As an optimization: the input module 1 may be devices such as a physical keyboard, a virtual keyboard, the output module 3 may be a display, and the processing and computing module 2 further comprises a processor.

The present invention has the advantages as follows:

1. the tone generation method of the Pythagorean tuning described by the present invention can be conveniently calculated by using formulas

$${f}_{i} = {f}_{0} ⨯ \frac{{3}^{i}}{{2}^{{g}_{i}}} , 1 \leq i \leq M and {f}_{j}^{′} = {f}_{0} ⨯ \frac{{2}^{{g}_{j}^{′}}}{{3}^{j}} , 1 \leq j \leq N .$$

For example, for any key, as long as the corresponding value range taken of each tone constituting the key is determined, the frequencies of the seven tones of this key can be calculated by using formulas. However, the traditional calculation method of the tone of Pythagorean tuning utilizes multiplication factors 2/3, 4/3, 3/2, and 3/4 for calculation, starting from the artificially specified initial frequency of the musical tuning, and generating the required tone for many times according to different tones. Every time a new tone is generated, it needs artificial judgment to choose which multiplication factor to use. In addition, to calculate any tone, it needs to start from the frequency of the starting tone of the tuning. For example, to calculate the seven tones of ^{#}C key, it is necessary to start from the frequency of the starting tone of the tuning, and calculate them one by one in sequence, that is, to calculate in this order f₀→f₁→f₂→f₃→f₄→f₅→f₆→f₇→f₈→f₉→f₁₀→f₁₁→f₁₂, and then select the last seven tones to constitute # C key. The tone generation method of the Pythagorean tuning described by the present invention directly calculates the frequencies of seven tones by utilizing calculation formula of the tone, which greatly facilitates the calculation of tones.

2. The tone generation method of the Pythagorean tuning described by the present invention can conveniently utilize the formula

$${f}_{i} = {f}_{0} ⨯ \frac{{3}^{i}}{{2}^{{g}_{i}}} , 1 \leq i \leq M and {f}_{j}^{′} = {f}_{0} ⨯ \frac{{2}^{{g}_{j}^{′}}}{{3}^{j}} , 1 \leq j \leq N$$

to calculate the frequency of the tone of any given generating tone number, and the frequency of the tone can be directly obtained only by calculating once. However, the traditional calculation method of the tone of Pythagorean tuning needs to calculate all the tones from the frequency of the starting tone of the tuning to the designated position. The present invention greatly improves the calculation efficiency.

The exponent calculation unit during upward process 20: it corresponds to the commonly used pure fifths upward method of Pythagorean tuning, and it generates the exponent of denominator upward from the frequency of the starting tone of the tuning to generate the required tone. By giving the tone calculation formula of fractional calculation, the present invention can directly calculate the tone without selecting the multiplication factor when utilizing the common method.

The exponent calculation unit during downward process 21: it corresponds to the commonly used pure fifths downward method of Pythagorean tuning, and it generates the exponent of molecule downward from the frequency of the starting tone of the tuning to generate the required tone. By giving the tone calculation formula of fractional calculation, the present invention can directly calculate the tone without selecting the multiplication factor when utilizing the common method.

The frequency value calculation unit 22: the exponent generated by the exponent calculation unit during upward process 20 and the exponent calculation unit during downward process 21 respectively calculate the upward M frequency values and the downward N frequency values by utilizing the formulas

$${f}_{i} = {f}_{0} ⨯ \frac{{3}^{i}}{{2}^{{g}_{i}}} , 1 \leq i \leq M and {f}_{j}^{′} = {f}_{0} ⨯ \frac{{2}^{{g}_{j}^{′}}}{{3}^{j}} , 1 \leq j \leq N .$$

In the era of digital music, music software can serve almost all music activities. Whether it is designing discrete pitched instruments,digital controllers or software instruments, music sampler, or during music composition, it is necessary to use tone calculation. For the convenience of calculation, most music software often adopts twelvetoneequal temperament, which are simple calculation and easy to understand. The calculation formula is:

$${f}_{k} = {f}_{0} ⨯ {2}^{\{ k ⨯ \frac{1}{12} \}} , k ∈ Z .$$

However, from the perspective of music theory, the equal temperament is an unharmonious tone tuning system. In the long musical practice of mankind, Pythagorean tuning is the most widely used tuning, but the commonly used method of generating tone of Pythagorean tuning needs some musical knowledge to understand, and its tone calculation formula is more complicated than the equal temperament, so its application range is greatly reduced.

The calculation formula of Pythagorean tuning provided by the present invention is as simple and easy to understand as the equal temperament, so that the present invention will greatly promote the diversified use of tone in the digital music era and provide technical support for enriching the industrial ecology of digital music products.

Finally, it should be noted that the above embodiments are only used to illustrate the technical solutions of the present invention, not to limit them; although the present invention has been described in detail with reference to the foregoing embodiments, those of ordinary skill in the art should understand that: the technical solutions recorded in the foregoing embodiments can still be modified, or some or all of the technical features can be equivalently replaced; and these modifications or replacements do not make the essence of the corresponding technical solutions deviate from the scope of the technical solutions in the embodiments of the present invention.

1. The calculation formula of Pythagorean tuning, comprising a generation system, the generation system comprises an input module, a processing and calculation module and an output module, and the processing and calculation module comprises an exponent calculation unit during upward process, a exponent calculation unit during downward process and a frequency value calculation unit, its specific steps are as follows:
step 1: inputting, by the input module, a frequency f₀ and the number N of downward tones and the number M of upward tones to be calculated, wherein the frequency f₀ is used as the frequency of the starting tone of the tuning;
step 2: obtaining a sequence G by the exponent calculation unit during upward process: calculating M values according to an exponent calculation formula gᵢ=└i×log₂3┘, 1≤i≤M to obtain an exponent sequence G;
step 3: obtaining a sequence G by the exponent calculation unit during downward process: calculating N values according to an exponent calculation formula gⱼ^{′}=└j×log₂3┘+1,1≤j≤N to obtain an exponent sequence G′;
step 4: obtaining, by the frequency value calculation unit, frequency values of the tones needed to be calculated: calculating the frequency values of the upward M tones according to a calculation formula to
$${f}_{i} = {f}_{0} ⨯ \frac{{3}^{i}}{{2}^{{g}_{i}}} , 1 \leq i \leq M$$
to obtain a sequence F of the upward M frequency values; and calculating frequency values of the downward N tones according to a calculation formula
$${f}_{j}^{′} = {f}_{0} ⨯ \frac{{2}^{{g}_{j}^{′}}}{{3}^{j}} , 1 \leq j \leq N$$
to obtain a sequence F′ of the upward N frequency values; and
step 5: outputting the tone sequences F and F′by the output module.

2. The calculation formula of Pythagorean tuning according to claim 1, wherein in the step 2, the exponent calculation formula of the exponent calculation unit during upward process is as follows: gᵢ=└i×log₂3┘,1≤i≤M, wherein └i×log₂3┘ represents an integer part value taken from the numerical value i×log₂3, and i represents an integer value from 1 to M, and M exponent values are calculated by the exponent calculation formula, and the calculated values are arranged from smallest to largest according to the size of subscript i, so as to obtain the sequence G, wherein the sequence G= [symbol] g₁, . . . , gᵢ₋₁, gᵢ, . . . , g_{M} [symbol] .

3. The calculation formula of Pythagorean tuning according to claim 1, wherein in the step 3, the exponent calculation formula of the calculation unit is as follows: gⱼ^{′}=└j×log₂3┘+1,1≤j≤N, where └j×log₂3┘ represents an integer part value taken from the numerical value and j represents an integer value from 1 to N, and N exponent values are calculated by the exponent calculation formula, and the calculated values are arranged from smallest to largest according to the size of subscript j, so as to obtain the sequence G′, wherein the sequence G′= [symbol] g₁^{′}, . . . , gⱼ, gⱼ₊₁^{′}, . . . , g_{N}^{′} [symbol] .

4. The calculation formula of Pythagorean tuning according to claim 1, wherein in the step 4, the calculation formulas of the tone sequence F and the tone sequence F′ are respectively
$${f}_{i} = {f}_{0} ⨯ \frac{{3}^{i}}{{2}^{{g}_{i}}} , 1 \leq i \leq M and {f}_{j}^{′} = {f}_{0} ⨯ \frac{{2}^{{g}_{j}^{′}}}{{3}^{j}} , 1 \leq j \leq N ,$$
which are products of a fractional ratio and the starting tone of the tuning, and a numerator and a denominator of the fractional ratio are exponential values with integers 2 and 3 as the base.
